(19) United States
(12) Patent Application Publication
(10) Pub. No.: US 2013/0073392 A1
(43) Pub. Date: Mar. 21, 2013

(54) METHODS AND APPARATUS FOR OBTAINING OFFLINE PURCHASE INFORMATION IN RESPONSE TO MULTIMEDIA ADVERTISING CAMPAIGNS

(71) Applicants: Geoffrey Benjamin Allen, Potomac Falls, VA (US); Steven Lee Geyer, Herndon, VA (US); Bradley Spector Herrup, Arlington, VA (US); Rodney Dale McElrath, Raleigh, NC (US); Timothy Scott Ramsey, Chantilly, VA (US)

(72) Inventors: Geoffrey Benjamin Allen, Potomac Falls, VA (US); Steven Lee Geyer, Herndon, VA (US); Bradley Spector Herrup, Arlington, VA (US); Rodney Dale McElrath, Raleigh, NC (US); Timothy Scott Ramsey, Chantilly, VA (US)

(73) Assignee: Ziplist, Inc., Sterling, VA (US)

(21) Appl. No.: 13/233,396

(22) Filed: Sep. 15, 2011

(51) Int. Cl. G06Q 30/00; H04W 4/02; G06Q 30/02

(52) U.S. Cl. 705/14.58; 705/14.4; 705/26.8

(57) ABSTRACT

In some embodiments, a non-transitory processor-readable medium stores code representing instructions to cause a processor to receive, at a time, an indication from a communication device that an item from a vendor-agnostic list has been located. The item having been previously added to a vendor-agnostic list in response to a user of the communication device perceiving an offline advertisement for the item, has been located. The code represents instructions to cause the processor to determine, based on a location indicator associated with the communication device, if the communication device is located within a range of a vendor substantially at the time. The code further represents instructions to cause the processor to store a relationship between an identifier associated with the offline advertisement and an identifier associated with the vendor if the communication device was located within the range of the vendor substantially at the time.

### CROSS-REFERENCE TO RELATED APPLICATION

This application is related to co-pending U.S. patent application having Attorney Docket No. ZIPL-001/00US 310590-2001, filed on the same date, and entitled “Methods and Apparatus for Managing a Universal List System,” which is incorporated herein by reference in its entirety.

### BACKGROUND

Embodiments described herein relate generally to obtaining offline purchase information and more particularly to methods and apparatus for obtaining offline purchase information based on a user managing a universal list.

Individuals often place items for which they intend to purchase on a shopping list. While shopping, such a shopping list can remind an individual of items they intend to purchase. Such shopping lists, however, can be easily lost. Additionally, manufacturers, retailers and/or vendors are unable to track when and where a user adds an item to their shopping list and/or when and where a user locates and/or purchases an item from their shopping list.

Accordingly, a need exists for methods and apparatus for obtaining offline purchase information based on a user managing a shopping list. Additionally, a need exists for methods and apparatus for tracking a user's offline shopping tendencies using a shopping list.

### SUMMARY

In some embodiments, a non-transitory processor-readable medium stores code representing instructions to cause a processor to receive, at a time, an indication from a communication device that an item from a vendor-agnostic list has been located. The item having been previously added to the vendor-agnostic list in response to a user of the communication device perceiving an offline advertisement for the item. The code represents instructions to cause the processor to determine, based on a location indicator associated with the communication device, if the communication device is located within a range of an identifiable location substantially at the time. The code further represents instructions to cause the processor to store a relationship between an identifier associated with the offline advertisement and an identifier associated with the identifiable location if the communication device was located within the range of the identifiable location substantially at the time.

### BRIEF DESCRIPTION OF THE DRAWINGS

FIG. 1 is a schematic diagram that illustrates communication devices in communication with a host device via a network, according to an embodiment.

FIG. 2 is a schematic illustration of a processor of a host device, according to another embodiment.

FIG. 3A is an illustration of a promotion database, according to another embodiment.

FIG. 3B is an illustration of a universal list database, according to another embodiment.

FIG. 4 is an illustration of a tracking database, according to another embodiment.

FIG. 5 is an illustration of a promotion database, according to another embodiment.

FIGS. 6 and 7 are flow charts illustrating methods of updating a tracking database, according to other embodiments.

### DETAILED DESCRIPTION

In some embodiments, a non-transitory processor-readable medium stores code representing instructions to cause a processor to receive, at a time, an indication from a communication device that an item from a vendor-agnostic list has been located. The item having been previously added to a vendor-agnostic list in response to a user of the communication device perceiving an offline advertisement for the item. The code represents instructions to cause the processor to determine, based on a location indicator associated with the communication device, if the communication device is located within a range of an identifiable location substantially at the time (e.g., within a relevant time window of the time). The code further represents instructions to cause the processor to store a relationship between an identifier associated with the offline advertisement and an identifier associated with the identifiable location if the communication device was located within the range of the identifiable location substantially at the time.

In some embodiments, the identifiable location can be a vendor. Using the relationship between the offline advertisement and the identifier associated with the vendor, an effectiveness of an offline advertisement can be evaluated. Similarly stated, a nexus can be established between an offline advertisement and an offline purchase. For example, such a relationship can be used to infer that an item associated with an offline advertisement was purchased. More specifically, it can be inferred that a user purchased the item when they removed the item from their list, changed a status of the item on the vendor-agnostic list to a located status (e.g., marked the item as located on a checklist), and/or the like. Moreover, such a relationship can be used to infer at which offline vendor and/or store an item associated with an offline advertisement was purchased. More specifically, it can be inferred that a user purchased the item at a store and/or vendor within a proximity and/or range of a location at which they removed the item from their list. Thus, a manufacturer and/or vendor can obtain information associated with a purchase of an item at an offline vendor and/or store. In other embodiments, the identifiable location can be a home of the user, a workplace of the user, and/or the like

In some embodiments, an apparatus includes a communication module and a tracking module. The communication module is configured to receive a first signal from a communication device at a time. The first signal indicates that an item on a vendor-agnostic list has been located. The communication module is configured to receive a second signal indicating a location of the communication device substantially at the time. The tracking module is configured to determine, based on the second signal, whether the communication device is located within a range of a identifiable location substantially at the time. The tracking module is configured to store a relationship between an identifier associated with the item, an identifier associated with the identifiable location, and an identifier associated with a user of the communication device if the communication device is located with a range of the identifiable location substantially at the time.

In some embodiments, a non-transitory processor-readable medium stores code representing instructions to cause a processor to update, at a first time, a vendor-agnostic list to include a set of identifiers associated with a set of items used to perform a process. The code represents instructions to cause the processor to receive, at a second time after a first time, a signal from a communication device that at least one item from the set of items has been located.

As used herein, a “universal list” (also referred to as a “vendor-agnostic list”) can include a list to which a user can add items. A universal list is vendor-agnostic and not specific and/or limited to any single vendor and/or entity. Accordingly, identifiers (e.g., names, pictures, etc.) of products from different manufacturers, sold at different stores and/or provided by different suppliers can be added to and/or removed from a universal list. Similarly, coupons from different stores and/or manufacturers can be added to and/or removed from a universal list. A user can use a universal list provided by a tracking system and/or service to shop for, locate and/or, as a reminder, to purchase the items on the universal list.

As used in this specification, the singular forms “a,” “an” and “the” include plural referents unless the context clearly dictates otherwise. Thus, for example, the term “module” is intended to mean a single module or a combination modules.

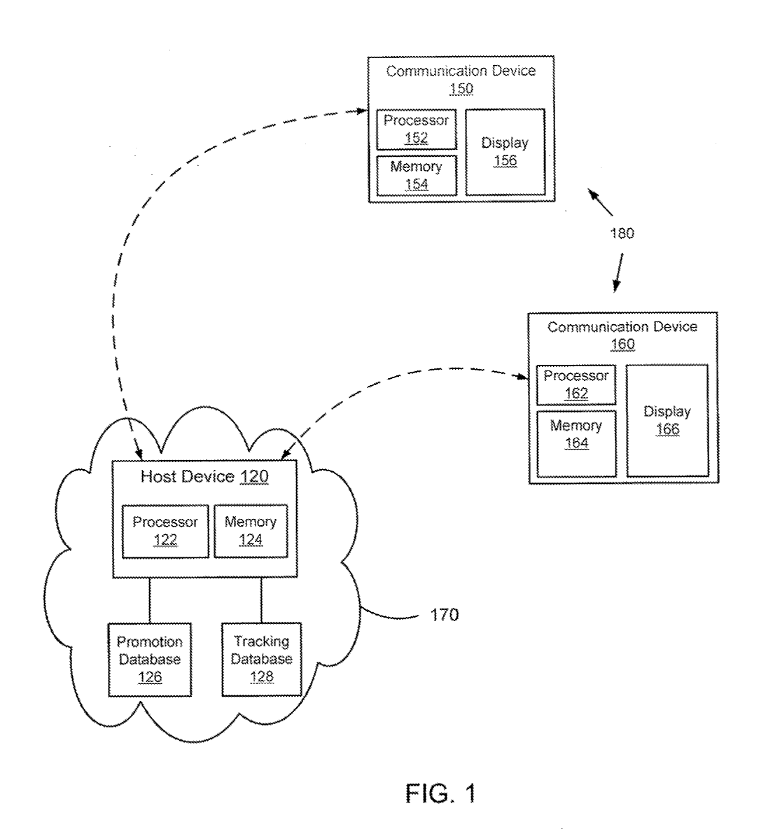

FIG. 1 is a schematic diagram that illustrates communication devices 180 in communication with a host device 120 via a network 170, according to an embodiment. Specifically, communication device 150 is configured to communicate with the host device 120. Similarly, communication device 160 is configured to communicate with the host device 120. The network 170 can be any type of network (e.g., a local area network (LAN), a wide area network (WAN), a virtual network, a telecommunications network) implemented as a wired network and/or wireless network. As described in further detail herein, in some embodiments, for example, the communication devices 180 are personal computers connected to the host device 120 via an Internet Service Provider (ISP) and the Internet (e.g., network 170).

In some embodiments, the communication devices 180 can communicate with the host device 120 and the network 170 via intermediate networks and/or alternate networks (not shown). Such intermediate networks and/or alternate networks can be of a same type and/or a different type of network as network 170. As such, in some embodiments, the communication devices 180 can send data to and/or receive data from the host device 120 using at least one communication mode (e.g., email, text messages (e.g., short message service (SMS) messages), instant messages, optical tag and/or pattern transmissions (e.g., scan of a pattern on a product's packaging, on an advertisement, etc.), radio frequency (RF) pattern transmissions, a mobile device application, a website, a personal computer (PC) application, an interactive advertisement (e.g., a Flash advertisement on a website), an interactive television (ITV) application (e.g., user uses their TV remote to select and/or enter promotion ID), TCP/IP transmissions, interactive voice response (e.g., via touch tones and/or voice recognition), etc.). For example, as described in further detail herein, the communication devices 180 can be mobile telephones or smart phones connected to the host device 120 via a cellular network and the Internet (e.g., network 170).

The host device 120 can be any type of device configured to send data over the network 170 to and/or receive data from one or more of the communication devices 180. In some embodiments, the host device 120 can be configured to function as, for example, a server device (e.g., a web server device), a network management device, a data repository and/or the like.

The host device 120 includes a memory 124 and a processor 122. The memory 124 can be, for example, a random access memory (RAM), a memory buffer, a hard drive, a database, an erasable programmable read-only memory (EPROM), an electrically erasable read-only memory (EEPROM), a read-only memory (ROM), and/or so forth. In some embodiments, the memory 124 of the host device 120 includes data used in a tracking system and/or service. More specifically, the memory 124 of the host device 120 can include data used to track offline purchase information, as described in further detail herein. In some embodiments, the memory 124 stores instructions to cause the processor to execute modules, processes and/or functions associated with such a tracking system and/or service.

The processor 122 of the host device 120 can be any suitable processing device configured to run and/or execute a tracking system and/or service. For example, the processor 122 can be configured to update a universal list and/or a user-performed process collection in response to receiving a signal from a communication device 180, as described in further detail herein. Additionally, the processor 122 can be configured to store tracking information associated with a promotion and/or advertisement. Such a promotion and/or advertisement can be presented to users through online advertisements (e.g., a website, an email transmission, a popup window, etc.) and/or offline advertisements (e.g., a television advertisement, a billboard advertisement, an audio advertisement (e.g., a radio advertisement, a podcast advertisement, etc.), an advertisement in a print medium (magazine, newspaper, coupon), a word-of mouth referral, etc.). In still other embodiments, the promotion and/or advertisement can be presented to the user by any other suitable manner. In some embodiments, the processor 122 can be a general purpose processor, a Field Programmable Gate Array (FPGA), an Application Specific Integrated Circuit (ASIC), a Digital Signal Processor (DSP), and/or the like.

The host device 120 is operatively coupled to a promotion database 126 and a tracking database 128. The promotion database 126 and the tracking database 128 can be any suitable databases such as, for example, relational databases, object databases, object-relational databases, hierarchical databases, network databases, entity-relationship databases, and/or the like. While shown in FIG. 1 as being separate from the host device 120, in other embodiments the promotion database 126 and the tracking database 128 can be part of the host device 120. For example, the promotion database 126 and the tracking database 128 can be stored in the memory 124. Additionally, while shown in FIG. 1 as being separate databases, in other embodiments the promotion database 126 and the tracking database 128 can be part of a single database. As described in further detail herein, the host device 120 (hosting the tracking system and/or service) can use the promotion database 126 and the tracking database 128 to track information associated with a promotion and a user's use of and/or participation in the promotion.

The promotion database 126 is configured to store and/or maintain data associated with a promotion. More specifically, the promotion database 126 can store and/or maintain an association between an identifier of a promotion and an item and/or product associated with that promotion. In some embodiments, the promotion database 126 can store additional information associated with the promotion, such as, for example, a vendor, a price, a store or group of stores, a manufacturer, a brand, a product identifier associated with an item (e.g., a universal product code (UPC), a stock-keeping unit (SKU), a serial number, a model number, etc.), a range of product identifiers associated with an item (e.g., certain brand, product line, etc.), and/or the like. Accordingly, as described in further detail herein, when the host device 120 receives a promotion identifier associated with a promotion, the host device can update a universal list to include an item and/or product associated with that promotion.

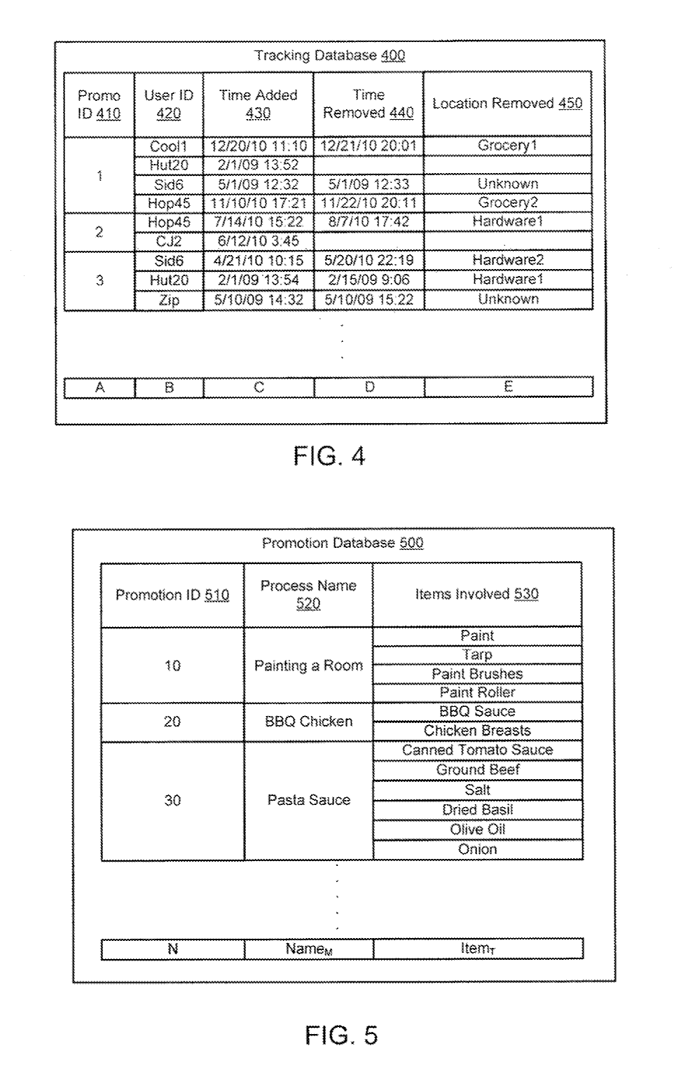

The tracking database 128 is configured to store and/or maintain data associated with a user's use of and/or participation in a promotion. More specifically, and as described in further detail herein with respect to FIG. 4, the tracking database 128 can store an association between a promotion identifier and the time when a user added an item associated with a promotion to a universal list, a location identifier of where the user added the item associated with the promotion from the universal list, the time when the user removed the item associated with the promotion from the universal list, and a location identifier of where the user removed the item associated with the promotion from the universal list. Similarly stated, the tracking database 128 can store an association between a promotion identifier and the time and/or the location at which a user provided an indication to a communication device 180 to add an item to or removed an item from their universal list. As described in further detail herein, such information can be used to track the use and effectiveness of a promotion and/or advertisement. Additionally, such information can be used to provide targeted promotions and/or advertisements to users.

Each of the communication devices 180 can be, for example, a computing entity (e.g., a personal computing device such as a desktop computer, a laptop computer, etc.), a mobile phone, a monitoring device, a personal digital assistant (PDA), an optical pattern and/or tag scanner (e.g., a high capacity color barcode scanner, a quick response (QR) code scanner, a two-dimensional barcode scanner, a one-dimensional barcode scanner, a black light pattern scanner, etc.), a radio frequency (RF) pattern scanner, a standard mobile telephone, a tablet PC, TV set top box, and/or so forth. Although not shown, in some embodiments, each of the communication devices 180 can include one or more network interface devices (e.g., a network interface card) configured to connect the communication devices 180 to the network 170. In some embodiments and for certain instances, the communication devices 180 can be referred to as client devices.

As shown in FIG. 1, the communication device 160 has a processor 162, a memory 164, and a display 166. The memory 164 can be, for example, a random access memory (RAM), a memory buffer, a hard drive, and/or so forth. The display 166 can be any suitable display, such as, for example, a liquid crystal display (LCD), a cathode ray tube display (CRT) or the like. Similar to communication device 160, the communication device 150 has a processor 152, a memory 154, and a display 156. In other embodiments, the communication devices 150, 160 include another output device instead of or in addition to the displays 156, 166. For example, the communication devices 150, 160 can include an audio output device (e.g., a speaker), a tactile output device, and/or the like.

In some embodiments, the communication device 160 can include a location module configured to receive location information. In some embodiments, for example, the location module can be a global positioning system (GPS) module, an assisted GPS module, a triangulation module, and/or the like. In response to receiving an indication to add an item to and/or remove an item from a universal list, the communication device 160 can receive location information (e.g., geo-coordinates) from the location module. As described in further detail herein, the communication device 160 can send such location information to the host device 120 such that the host device 120 can process the location information and/or store the location information in the tracking database 128. Similar to the communication device 160, communication device 150 can include a location module configured to receive location information.

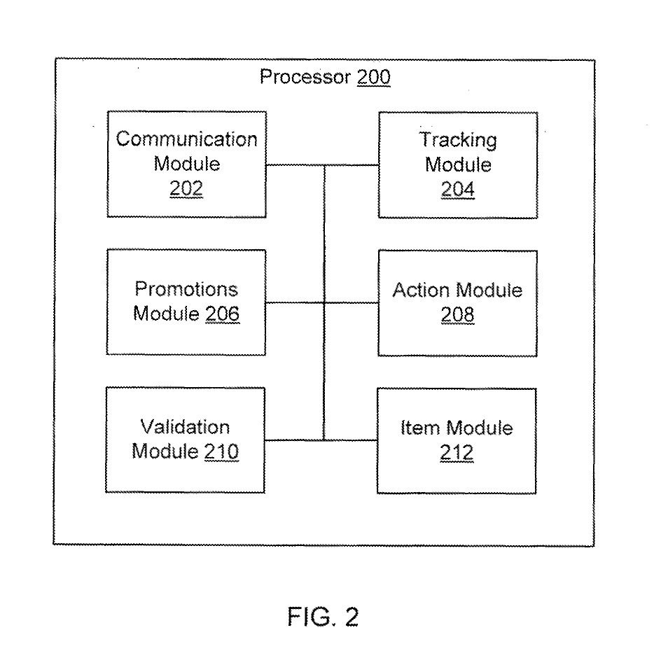

In some embodiments, one or more portions of the communication devices 180 can include a hardware-based module (e.g., a digital signal processor (DSP), a field programmable gate array (FPGA)) and/or a software-based module (e.g., a module of computer code stored in memory and/or executed at a processor). In some embodiments, one or more of the functions associated with the host device 120 (e.g., the functions associated with the processor 122) can be included in one or more modules (e.g., shown in FIG. 2). In some embodiments, one or more of the functions associated with the communication devices 180 (e.g., functions associated with processor 152 or processor 162) can be included in one or more modules. In some embodiments, one or more of the communication devices 180 can be configured to perform one or more functions associated with the host device 120, and vice versa.

FIG. 2 is a schematic illustration of a processor 200 of a host device hosting a tracking system and/or service, according to another embodiment. In some embodiments, the processor 200 can be similar to the processor 122 of the host device 120. More specifically, the processor 200 can be any suitable processing device configured to run and/or execute a tracking system and/or service.

The processor 200 includes a communication module 202, a tracking module 204, a promotions module 206, an action module 208, a validation module 210, and an item module 212. While each module is shown in FIG. 2 as being in direct communication with every other module, in other embodiments, each module need not be in direct communication with every other module. Moreover, in other embodiments, any other number of modules can be included within the processor 200.

The communication module 202 is configured to receive a message from a communication device (e.g., communication device 150 or 160) via a communication mode (e.g., email, text messages (e.g., SMS messages), instant messages, optical pattern transmissions (e.g., scan of a barcode on a product's packaging, on an advertisement, etc.), RF pattern transmissions, a mobile device application, a website, a PC application, an interactive advertisement (e.g., a Flash advertisement on a website), an ITV application (e.g., user uses their TV remote to select and/or enter promotion ID), TCP/IP transmissions, interactive voice response (e.g., via touch tones and/or voice recognition), etc.). More specifically, the communication module 202 can be configured to receive a message having a promotion identifier associated with an item via a communication mode. While shown and described with respect to FIG. 2 as having a single communication module 202, in other embodiments, the processor 200 can include any number of communication modules 202 each configured to receive messages from a communication device via a different communication mode. Such a processor can be similar to the processor shown and described in U.S. patent application having Attorney Docket No. ZIPL-001/00US 310590-2001, filed on the same date, and entitled “Methods and Apparatus for Managing a Universal List System,” which is incorporated herein by reference in its entirety.

In some embodiments, a user can also send commands to the processor 200 (i.e., via the communication module 202) to add items to a universal list, update items on the universal list (e.g., update a quantity of the item) and/or remove the items from the universal list. In such embodiments, for example, the user can provide a command and/or instruction with the promotion identifier when sending a message to the processor 200. Such a command and/or instruction can be sent using any suitable format, such as, for example, <command, promotion ID>. For example, as described in further detail herein, if the processor 200 receives an instruction of <remove, 1> via the communication module 202, the processor 200 can remove an item having the promotion identifier of “1” from the universal list. For another example, if the processor 200 receives an instruction of <add, 2> via the communication module 202, the processor 200 can add an item having the promotion identifier of “2” to the universal list.

In some embodiments, such commands can include a store identifier. For example, a user can assign a store when sending an instruction to remove an item from their universal list. For example, the command <remove, 1, store x> can remove the item with the promotion ID of “1” from their universal list. Such a command can also indicate that they purchased the item with the promotion ID of “1” at “store x.” For another example, a user can assign a store when sending an instruction to add an item to their universal list. For example, the command <add, 5, store y> can add the item with the promotion ID of “5” to their universal list. Such a command can also indicate that they intend to purchase the item with the promotion ID of “5” at “store y.” Such an indication can be used to add a price of the item with the promotion ID of “5” at “store y” to the user's universal list.

A promotion identifier can be presented to the user in any suitable manner. Similarly stated, a user can obtain a promotion identifier in any suitable manner. In some embodiments, for example, the promotion ID can be presented to a user of a communication device using online advertisements (e.g., a website, an email transmission, a popup window, on a mobile device application, etc.) and/or offline advertisements (e.g., a television advertisement, a billboard advertisement, an audio advertisement (radio advertisement, podcast advertisement), an advertisement in a print medium (magazine, newspaper, coupon), a word-of mouth referral, etc.). In still other embodiments, the promotion ID can be presented to the user in any other suitable manner. Additionally, the promotion ID can be presented to a user in any suitable form. For example, the promotion ID for an item, promotion and/or process can be presented to a user using the actual numerical promotion ID (e.g., visually, audibly and/or tactilely), an optical pattern (e.g., a high capacity color barcode, a QR code, a two-dimensional barcode, a one-dimensional barcode, a black light pattern, etc.), an RF pattern, within an application on a PC or mobile device, and/or the like. In some embodiments, the promotion ID can be a name associated with the item. For example, a promotion ID for Skim Milk can be “Skim Milk.” In some embodiments, the name associated with the item can be a generic name to add a generic item (e.g., white paint) and/or a specific name to add a specific product and/or brand of product (e.g., Brand Y White Paint).

The item module 212 can be configured to query a promotion database (e.g., promotion database 126 shown and described with respect to FIG. 1) for an item associated with a promotion and/or advertisement. For example, after receiving a promotion identifier of a promotion, the communication module 202 can send the promotion identifier to the item module 212 such that the item module 212 can use the promotion identifier to query the promotion database. Based on the promotion identifier, the item module 212 can retrieve an item identifier of an item associated with the promotion identified by the promotion identifier.

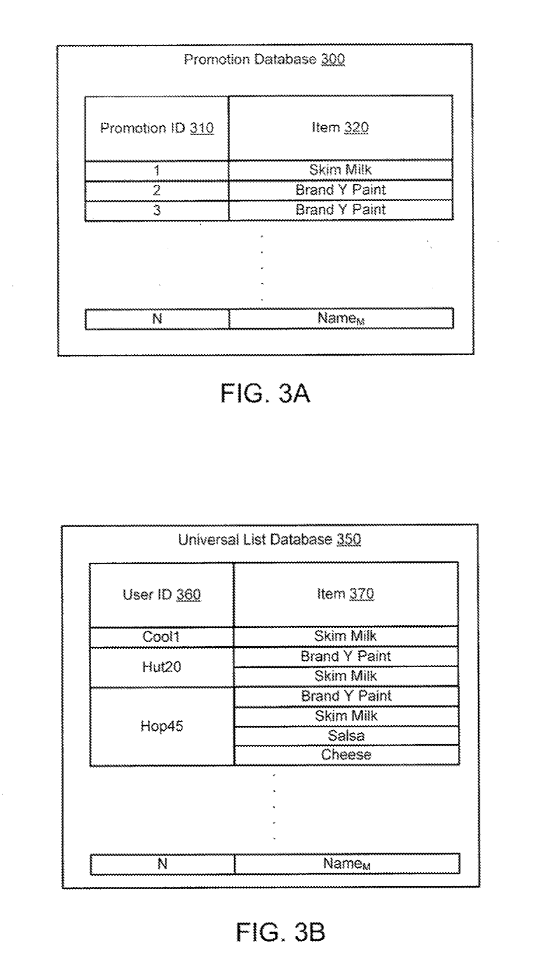

FIG. 3A, for example, illustrates a promotion database 300. The promotion database 300 can be structurally and functionally similar to the promotion database 126 shown and described with respect to FIG. 1. The promotion database 300 includes a promotion identifier (ID) column 310 and an item column 320. The promotion ID column 310 can include promotion identifiers associated with a promotion, and the item column 320 can include an indicator (e.g., a name) of an item associated with that promotion. For example, the promotion identifier of “1” identifies a promotion for “Skim Milk.” Similarly, the promotion identifiers “2” and “3” identify two different promotions for “Brand Y Paint.” In some embodiments, for example, the promotion having the promotion identifier of “2” can be associated with a television advertisement and the promotion having the promotion identifier of “3” can be associated with a print advertisement. Accordingly, as described in further detail herein, using a different promotion identifier for different promotions for the same item and/or product allows a vendor and/or manufacturer to deter mine the effectiveness of the promotions associated with different advertisement mediums.

While shown in FIG. 3A as a numeric identifier, the promotion identifier can include any number and combination of alphanumeric characters. In some embodiments, for example, the promotion identifier can be an alphanumeric string such as, for example, “skim milk”, “davesbbqchicken”, “pastasauce179”, “ming608”, “currychicken”, “roompainting”, and/or the like. In some embodiments, the promotion ID can be a random identifier. In other embodiments, a first portion of the promotion ID can be predetermined (e.g., a prefix associated with a domain name, brand, company, etc.) and a second portion of the promotion ID can be random.

In some embodiments, the promotion IDs can be defined using one or more specific processes. For example, such a process can include removing alphanumeric characters that may cause confusion (e.g., ones (1) and els (l), and zeros (0) and o's), making the promotion IDs case insensitive, removing expletives and/or inappropriate words from the promotion IDs, removing vowels from the promotion IDs, limiting placement and/or a number of vowels within a promotion ID, and/or the like.

Returning to FIG. 2, the validation module 210 can be configured to query a user database (not shown in FIG. 2) for a user identifier and/or account number. In some embodiments, the validation module 210 can query the user database using a telephone number, an email address, an instant message identifier, a social network account username and/or password, a private third party authentication identifier (e.g., user logs in with the third party), and/or any other communication identifier. For example, if the communication module receives an SMS message from a telephone, the validation module 210 can query the user database to determine with which user and/or account the telephone number of that telephone is associated. Similarly, if the communication module 202 receives an email from an email address or an instant message from an instant message account having an instant message username, the validation module 210 can query the user database to determine with which user and/or account the email address or instant message username is associated. Such a user database can be similar to the user database shown and described in U.S. patent application having Attorney Docket No. ZIPL-001/00US 310590-2001, filed on the same date, and entitled “Methods and Apparatus for Managing a Universal List System,” which is incorporated herein by reference in its entirety.

In some embodiments, additional verification can be used to ensure that a user sending a promotion ID via a communication mode is the user associated with the identifier (e.g., the phone number, email address, IM ID, username, etc.) received with the promotion ID. In such embodiments, for example, a user can be asked to supply a username, a password, a personal identification number (PIN), a token and/or the like to the tracking system and/or service when attempting to add one or more items to their universal list. For example, when logging into a mobile application and/or website, the user can supply a username and/or a password. For another example, when emailing a promotion ID to a tracking system and/or service, the user can provide a PIN with the email, the user can be asked to provide a PIN in a response email and/or the user can be asked to provide a PIN at a link provided by a response email. For yet another example, in response to emailing a promotion ID to a tracking system and/or service, the user can be sent a response email having a link (e.g., embedded with a user ID, PIN, and/or token) to confirm the addition of the one or more items to their universal list. After the user selects the link, the item can be added to the users universal list. In other embodiments, such a link can be to a website at which the user can provide additional identification (e.g., a token, a password, a PIN, etc.). In other embodiments, any other combination of verification methods can be used to increase security of a user's universal list. In some embodiments, the identifiers, PINs, usernames, passwords and/or any other information sent between the processor 200 and a communication device can be encrypted.

In some embodiments, different levels and/or types of verification can be used depending on the communication mode used to send the promotion ID. For example, if a user sends an SMS message containing a promotion ID to a tracking system and/or service, the tracking system and/or service might not ask for another form of identification. For another example, if a user sends a promotion ID to a tracking system and/or service using an instant messaging service, the tracking system and/or service might ask for an additional PIN and/or password (e.g., within a browser window) before the item(s) is added to the universal list. In some embodiments, a user can set, define and/or change permission and verification levels (e.g., the number and type of verification mode(s)) for each communication mode associated with their account.

The action module 208 can be configured to update (e.g., edit, add to, remove from, etc.) a universal list associated with a user of the tracking system and/or service. More specifically, the action module 208 is configured to receive item identifiers from the item module 212 and a user ID and/or account number from the validation module 210. Based on the user ID and/or account number, the action module 208 can add the item identifiers to a universal list associated with that user ID and/or account number. As described in further detail herein, in some embodiments, the action module 208 can perform additional actions with respect to a universal list. In some embodiments, for example, the action module 208 can define a new universal list, share a universal list with another user, associate additional attributes with an item and/or process on the universal list and/or the like.

In some embodiments, for example, if a user sends an email containing the instruction “add” and the promotion identifier “1” to the processor 200 from a registered email address, the action module 208 can update that user's universal list to include “Skim Milk.” For another example, if a user sends a text message containing the instruction “remove” and the promotion identifier “2” to the processor 200 from a registered text message account, the action module 208 can remove “Brand Y Paint” from that user's universal list.

In some embodiments, the action module 208 can also update a user-performed process collection. Such a user-performed process collection can be a grouping and/or collection of user-performed processes associated with a user (e.g., that a user has added to their user-performed process collection). In some embodiments, a user-performed process collection includes items, instructions and/or directions to perform a user-performed process (e.g., a recipe, a home improvement project, etc.). For example, a user-performed process collection can be a recipe box, a home improvement project collection, and/or the like. In some embodiments, the action module 208 can associate a user-performed process with a user's user-performed process collection in response to receiving a promotion ID associated with that user-performed process (also called a process ID) from a communication mode (e.g., email, text messages (e.g., SMS messages), instant messages, optical pattern transmissions (e.g., scan of a barcode on a product's packaging, on an advertisement, etc.), RF pattern transmissions, a mobile device application, a website, a PC application, an interactive advertisement (e.g., a Flash advertisement on a website), an ITV application (e.g., user uses their TV remote to select and/or enter promotion ID), TCP/IP transmissions, interactive voice response (e.g., via touch tones and/or voice recognition), etc.) associated with that user. In such embodiments, a user can view the user-performed processes stored in their user-performed process collection at a later time by accessing their user-performed process collection (e.g., via a website).

In some embodiments, the action module 208 can update a universal list database that stores each user's universal list. FIG. 3B, for example, illustrates a universal list database 350. The universal list database 350 includes a user ID column 360 and an item column 370. The user ID column 360 can include a list and/or entry for each user having a universal list. The item column 370 can include the items associated with the users in the user ID column 360. For example, the universal list associated with the user ID “Cool1” includes “Skim Milk,” the universal list associated with user ID “Hut20” includes “Brand Y Paint” and “Skim Milk,” and the universal list associated with the user ID “Hop45” includes “Brand Y Paint,” “Skim Milk,” “Salsa,” and “Cheese.” In some embodiments, based on a user ID and/or account number, the action module 208 can add item identifiers associated with one or more items to the record of that user's universal list in the universal list database 350. Thus, if the user having the user ID of “Cool1” sends the promotion ID of “2” to communication module 202 of processor 200, the action module 208 can add “Brand Y Paint” to a row associated with “Cool1” in the universal list database 350. Similarly, if the action module 208 receives an indication from a communication device associated with the user “Hut20” to remove the item associated with promotion ID “1” (e.g., via communication module 202), the action module 208 can remove the row in the universal list database 350 associating “Skim Milk” with the user “Hut20.” In other embodiments, instead of removing the row associating “Skim Milk” with the user “Hut20,” the row can be marked inactive.

A user can access, update and/or view their universal list by accessing the universal list database 350 via a communication device. More specifically, a host device can query the universal list database 350 for an indicator of each item associated with a user ID and send the indicators to the communication device. The communication device can use the indicators to render the list on a display.

In some embodiments, such a universal list database 350 can be stored at and/or coupled to, for example, a host device (e.g., such as host device 120 of FIG. 1). In other embodiments, the record of each user's universal list can be stored locally at a communication device (e.g., communication device 150 or 160 of FIG. 1).

In some embodiments, a user can decide whether to add a user-performed process to their user-performed process collection, to add the items associated with the user-performed process to their universal list, and/or both. In such embodiments, in response to receiving a promotion ID, the tracking system and/or service performed by processor 200 can, for example, present an option to a user (e.g., via the communication module 202). The user can then select (e.g., on a communication device) to add the user-performed process associated with that promotion ID to their user-performed process collection, to add the items associated with the user-performed process associated with that promotion ID to their universal list, and/or both.

In other embodiments, whether or not the user is presented such an option can be based on the promotion ID. In such embodiments, for example, in response to receiving a first promotion ID, the tracking system and/or service performed by processor 200 can, for example, present such an option to a user (e.g., via the communication module 202), while in response to receiving a second promotion ID, the tracking system and/or service can automatically add the user-performed process associated with the second promotion ID to the user's user-performed process collection, automatically add the items associated with the user-performed process to the user's universal list, and/or both. In some embodiments, a company associated with the promotion ID (e.g., a retailer, a brand, a company, etc.) can determine whether or not to provide such an option to users.

The tracking module 204 can be configured to track when and/or where a user updates (e.g., adds, edits, and/or removes) an item on their universal list. For example, the tracking module 204 can be configured to interface with a tracking database (e.g., tracking database 128 shown and described with respect to FIG. 1) to store and/or maintain information and/or data associated with a user updating an item on their universal list. More specifically, the tracking module 204 can include a timer function and a locator function. The timer function can be configured to determine a time that a user adds an item to a universal list, a time that a user removes an item from a universal list, and/or a time a user edits an item on a universal list. The tracking database can store such times in the tracking database (see, e.g., FIG. 4 discussed below). In other embodiments, such time information can be sent to the tracking module 204 (via communication module 202) from a communication device with a message to add an item to, edit an item on and/or remove an item from a universal list.

The locator function can be configured to store a location of a communication device when a message to add an item, update an item and/or remove an item is received by the communication module 202. In some embodiments, for example, the locator function can obtain location information (e.g., geo-coordinates) from a location module on the communication device (not shown). Such a location module can be, for example, a global positioning system (GPS) module, an assisted GPS module, a triangulation module (e.g., using cellular towers), a signal (e.g., audible tone) from a wireless transceiver or base-station (e.g., within a store and/or vendor), and/or the like. In some embodiments, such location information can be sent to the tracking module 204 (via communication module 202) from a communication device with a message to add an item to, edit an item on and/or remove an item from a universal list. In other embodiments, such location information can be sent to the tracking module 204 (via communication module 202) within a dedicated message within a time period after the message to add an item to, edit an item on and/or remove an item from a universal list.

In some embodiments, the locator function attempts to acquire position and/or location information in response to the communication device receiving an indication to remove an item from, update an item at and/or add an item to a universal list. If the communication device is able to acquire position information substantially at a time in which the indication to remove an item from, update an item at and/or add an item to a universal list is received, such information can be sent with the message to add an item to, update an item at and/or remove an item from a universal list. In some embodiments, if the locator function is unable to acquire location information (e.g., a GPS module does not have a clear view of the sky), the locator function can periodically attempt to acquire such information until the location information is received. In such embodiments, the communication device can send such delayed position information to the communication module 202 after it is received. In some embodiments, the locator module sends an error message to the host device if the locator function is unable to acquire location information after a predetermined time period.

Using the location information (e.g., geo-coordinates associated with the communication device), the tracking module 204 can query a location database (not shown) to determine if the communication device is within a range of an identifiable location (e.g., a vendor, a store, a home, an office and/or the like) in response to the communication module 202 receiving a message to remove, add and/or edit an item. For example, the location database can store an association between the location information (e.g., geo-coordinates) of a vendor and a name and/or identifier of the vendor. If, for example, the tracking module 204 determines that the communication device was within a range of a vendor (e.g., by comparing the geo-coordinates of the communication device with the geo-coordinates of the vendor) at substantially the time (e.g., within a time period) at which an instruction to remove an item was received at the communication device (e.g., from a user of the communication device), the tracking module 204 can store a name and/or identifier of the vendor in the tracking database 400. Similarly, if, for example, the tracking module 204 determines that the communication device was within a range of an advertisement (e.g., a billboard, a vendor, at home, at work, etc.) at substantially the time at which a message to add an item was received at a communication device (e.g., from a user of the communication device), the tracking module 204 can store a name and/or identifier of the advertisement and/or location in the tracking database 400 (discussed below).

In some embodiments, for example, if a user removes an item from their universal list in the vicinity of a vendor, it can be inferred that the user removing the item from their universal list purchased the item at that vendor. Thus, in such embodiments, the tracking module 204 can be used to infer a vendor at which a user purchases particular items and/or products. Similarly, it can be inferred that a user added an item to their universal list in response to an advertisement being perceived at a specific location represented by the geo-coordinates (e.g., a billboard, a vendor, at home, at work, etc.). Accordingly, the tracking module 204 can be used to infer a location at which a user perceives advertisements for particular promotions and/or products.

In some embodiments, the tracking module 204 can infer that a user purchased an item at a vendor if location information associated with the communication device is received substantially at a time (e.g., within a time period) at which the user provided an indication to remove the item from their list. Similarly stated, if a communication device acquires location information within a time period after the user provides an indication to remove an item from their list, this location information can be used by the tracking module 204 to infer a vendor and/or store at which the user purchased the item. In some embodiments, if, however, the communication device is unable to acquire location information within the time period after the user provides an indication to remove the item from their list, any subsequently received location information is deemed outdated and not used by the tracking module 204 to infer a vendor and/or store at which the user purchased the item. In some embodiments, a similar process and/or method can be used to determine whether to use location information associated with adding an item to and/or updating an item on a universal list.

FIG. 4 illustrates an example of a tracking database 400. The tracking database 400 can be similar to the tracking database 128 (FIG. 1) and can be configured to store and/or maintain data associated with a user's use of and/or participation in a promotion. The tracking database 400 includes a promotion identifier (Promo ID) column 410, a user identifier (ID) column 420, a time added column 430, a time removed column 440 and a location removed column 450. The promotion identifier column 410 includes promotion identifiers that correspond to the promotion identifiers in the promotion database 300 (FIG. 3A). The user identifier column 420 includes user identifiers associated with the users of the tracking system that have added items associated with a promotion to their universal list. For example, the users having the user identifiers of “Cool1,” “Hut20,” “Sid6,” and “Hop45” have added the item (Skim Milk) associated with the promotion identifier of “1” to their universal list using the promotion identifier of “1.”

The time added column 430 includes a date and/or time that each user added an item to their universal list. For example, the user having the user identifier of “Cool1” added “Skim Milk” to their universal list on 12/20/10 at 11:10 am. For another example, the user having the user identifier of “Hop45” added “Brand Y Paint” to their universal list on 7/14/10 at 15:22 (i.e., 3:22 pm) in response to an advertisement and/or promotion associated with the promotion identifier of “2”. Similar to the time added column 430, the time removed column 440 includes a date and/or time that each user removed an item from their universal list. For example, the user having the user identifier of “Cool1” removed “Skim Milk” from their universal list on 12/21/10 at 20:01 (i.e., 8:01 pm). For another example, the user having the user identifier of “Hop45” removed “Brand Y Paint” from their universal list on 8/7/10 at 17:42 (i.e., 5:42 pm). Accordingly, using the time added column 430 and the time removed column 440 a vendor and/or manufacturer can determine at what times users provided an indication to a communication device to add and/or remove items from their universal lists.

The location removed column 450 can include an identifier of an identifiable location (e.g., a vendor, a store, a home, an office and/or the like) at which an item was removed from a user's universal list. More specifically, and as described above, the tracking module 204 can receive the geo-coordinates received at a communication device substantially at the time the item was removed from the user's universal list (e.g., via an instruction from a user).

The tracking module 204 can compare the geo-coordinates received from the communication device with geo-coordinates of multiple identifiable locations (e.g., stored in a location database). If the geo-coordinates received from the communication device are within a range, radius and/or distance of geo-coordinates of an identifiable location, the tracking module 204 can store an identifier of the store in the location removed column 450 of the tracking database 400. For example, the tracking module 204 determined that the communication device at which the user having the user identifier of “Cool1” removed the item “Skim Milk” from their universal list was within a range, radius and/or distance from the vendor “Grocery1” when a user provided an instruction (e.g., to a communication device) to remove the item “Skim Milk” from the universal list. Accordingly, the identifier associated with the vendor “Grocery1” is stored in the location removed column 450. Thus, the vendor and/or manufacturer can infer that the user having the user identifier of “Cool1” purchased “Skim Milk” from the vendor “Grocery1” based on the promotion (e.g., advertisement) having the promotion ID of “1”. If the geo-coordinates received from the communication device are not within a range of geo-coordinates of an identifiable location, the tracking module 204 can store an indicator indicating that the geo-coordinates of the communication device were not within a range of geo-coordinates of an identifiable location when a user provided an instruction to remove an item from the universal list. For example, the user having the identifier of “Zip” removed the “Brand Y Paint” associated with the promotion identifier “3” at an unknown location. Accordingly, no inference as to where the user having the identifier of “Zip” purchased the “Brand Y Paint” is made. In other embodiments, the location removed column 450 can include geo-coordinates rather than or in addition to an identifier of an identifiable location.

In some embodiments, a type of item removed from a universal list can be used to assist in determining at which store and/or vendor a user purchased an item. For example, if the item is typically sold in a grocery store, then non-grocery stores within the range, radius and/or distance of the removal location are not considered as possible stores at which the item was purchased. Similarly, for another example, if the item is typically sold in a hardware store, hardware stores (and not other types of stores) within the range, radius and/or distance of the removal location are considered as possible stores at which the item was purchased.

In some embodiments, the location removed column 450 can include more than a single location. In such embodiments, for example, the location removed column 450 can include the possible stores and/or vendors within the range, radius and/or distance of the removal location. In some embodiments, such a list of possible stores and/or vendors can be narrowed based on user preference (e.g., generally prefers one store over another), a user's prior shopping habits (e.g., generally shops at a particular store), the type of item removed from the list (e.g., generally sold at a hardware store, grocery store, etc.) and/or the like.

In some embodiments, the tracking database 400 can include a location added column (not shown in FIG. 4). Such a location added column can store a location at which a user added an item to their universal list. The location added column can be used to infer an identifiable location at which a user perceives advertisements for particular promotions and/or products. Accordingly, such a location added column can be used to assess the effectiveness of particular advertisement locations for particular products. For example, if the location at which the user provided an instruction (e.g., to a communication device) to add an item to their universal list is determined to be a road or parking lot and the promotion ID is associated with a radio advertisement, it can be inferred that the radio advertisement was heard by the user while in the car, but not at home or work.

Returning to FIG. 2, the promotions module 206 can be configured to deliver a promotion to a user based on the information and/or data stored in the tracking database 400. For example, the promotions module 206 can deliver a coupon for “Skim Milk” at the vendor “Grocery1” to the user having the user identifier of “Cool1” based on the user previously purchasing “Skim Milk” at the vendor “Grocery1.” For another example, the promotions module 206 can deliver a coupon for tarps, paint brushes and/or other painting supplies at the vendor “Hardware1” to the user having the user identifier of “Hop45” based on the user previously purchasing “Brand Y Paint” at the vendor “Hardware1.” Accordingly, targeted advertisements and/or promotions can be provided to a user based on a history of that user's use of a universal list.

In some embodiments, the user can present the coupon (e.g., that can be stored in a memory) via a communication device (e.g., a mobile telephone, PDA, etc.) when purchasing the item(s) associated with the coupon. In such embodiments, for example, the representation of the coupon can be an optical pattern (e.g., a high capacity color barcode, a QR code, a two-dimensional barcode, a one-dimensional barcode, a black light pattern, etc.), a number, and/or the like, associated with the coupon and/or a link to an optical pattern, a number and/or the like, associated with the coupon. In some embodiments, the user can have the option to print the coupon, email the coupon, and/or the like. For example, a link can be presented to the user via which the user can access and print and/or email a copy of the coupon.

In some embodiments, coupons and/or promotions can be associated with a user's universal list based on a vendor's loyalty program. For example, a user's universal list can be associated with a loyalty card program, a frequent shopper program, and/or the like. In such embodiments, a vendor can add vendor specific coupons associated with that vendor's loyalty program (e.g., based on purchases made at the vendor, deals of the week at the vendor, etc.) to the user's universal list. In such embodiments, the coupon can be associated with the user based on their loyalty program identifier. Thus, the user can obtain the promotion associated with the coupon upon presenting their loyalty program identifier to the vendor.

While shown and described above as being associated with a single item, in some embodiments a promotion identifier can be associated with multiple items. For example, a promotion identifier can be associated with a user-performed process, such as, for example, a recipe, a home improvement project, and/or the like. More specifically, a promotion identifier can be associated with the items and/or instructions used to complete and/or perform the user-performed process.

FIG. 5 illustrates a promotion database 500 configured to store an association between a promotion identifier associated with a user-performed process and the items used to complete and/or perform the user-performed process. The promotion database 500 includes a promotion identifier (ID) column 510, a process name column 520, and an items involved column 530. The promotion ID column 510 can include promotion identifiers associated with user-performed processes, the process name column 520 can include a name and/or title of the user-performed process, and the items involved column 530 can include a name, title and/or item identifier associated with items used to perform and/or complete the user-performed process. For example, the promotion ID “10” can be associated with a user-performed process having a process name of “Painting a Room.” The items involved with the user-performed process of “Painting a Room” can include (1) Paint, (2) Tarp, (3) Paint Brushes, and (4) Paint Roller. For another example, the promotion ID “20” can be associated with a user-performed process having a process name of “BBQ Chicken.” The items involved with the user-performed process of “BBQ Chicken” can include (1) BBQ Sauce and (2) Chicken Breasts. Accordingly, using the items associated with the promotion ID “10”, a user can paint a room. Similarly, using the items associated with the promotion ID “20”, a user can cook BBQ chicken.

While not shown in FIG. 5, in some embodiments, the promotion database 500 can include quantity information for the items associated with a process. For example, the item identifiers (i.e., BBQ Sauce and Chicken Breasts) for the process of “BBQ Chicken” can include “2 Cups of BBQ Sauce” and “2 Chicken Breasts.” Accordingly, a user can determine a quantity and/or amount of each item to purchase to complete and/or perform the process.

While not shown in FIG. 5, in some embodiments the promotion database 500 can store a relationship between a promotion identifier of a user-performed process (also called a process identifier) and directions and/or instructions used to implement and/or perform that user-performed process. In such embodiments, for example, the promotion database 500 can include instructions for “Painting a Room” associated with the promotion ID “10”. For another example, the promotion database 500 can include instructions for cooking “BBQ Chicken” associated with the promotion ID “20”. In some embodiments and as described above, an action module (e.g., action module 208 of FIG. 2) can add the directions and/or instructions used to implement and/or perform a user-performed process to a user's user-performed process collection in response to a promotion ID associated with that user-performed process being received. In such embodiments, a user can view the user-performed processes stored in their user-performed process collection at a later time by accessing their user-performed process collection (e.g., via a website).

In some embodiments, the promotion database 500 can also store metadata associated with various user-performed processes. In such embodiments, for example, the promotion database 500 can store a difficulty associated with a user-performed process, a preparation time associated with a user-performed process, an execution time (e.g., cook time) associated with a step of a user-performed process, a total time to complete associated with a user-performed process, and/or the like. Such information can be added to a user's universal list and/or user-performed process collection when that user-performed process is added to the user's universal list and/or user-performed process collection.

In some embodiments, a user can add, edit and/or remove the items associated with the process from their universal list by sending the promotion identifier associated with a user-performed process to a host device. More specifically, as described above, a user can send commands to a host device (e.g., a processor of the host device) to add items to a universal list, update items on the universal list (e.g., update a quantity of the item) and/or remove the items from the universal list. For example, if the host device receives an instruction of <remove, 10>, the host device can remove the items associated with the promotion identifier “10” (e.g., the items used to perform and/or complete the process of “Painting a Room”) from the universal list. For another example, if the host devices receives an instruction of <add, 20>, the host device can add the items associated with the promotion identifier of “20” (e.g., the items used to perform and/or complete the process of “BBQ Chicken”) to the universal list.

In other embodiments, each item associated with a user-performed process can also include a unique identifier. In such embodiments, using the identifier associated with a specific item, a user can send a message to add, edit, and/or remove that item from their universal list. Accordingly, in such embodiments, a user can add, edit, and/or remove the items associated with a user-performed process individually and/or collectively.

Similar to the tracking database 400 shown and described with respect to FIG. 4, a tracking database can be updated (e.g., using a tracking module similar to the tracking module 204 shown and described with respect to FIG. 2) based on a user adding the items associated with a user-performed process to their universal list. More specifically, the tracking database can include data associated with when and/or where the user added the items associated with the user-performed process to their universal list and/or when and/or where the user removed the items associated with the user-performed process from their universal list. In some embodiments, a tracking module can store, in the tracking database, a location at which the user removed the user-performed process in response to the user removing, from the universal list, a single item from the items associated with the user-performed process. In other embodiments, a tracking module can store, in the tracking database, a location at which the user removed the user-performed process in response to the user removing, from the universal list, every item associated with the user-performed process as a group. In still other embodiments, the tracking module stores a location removed in the tracking database for each individual item removed and not for the user-performed process as a whole.

In some embodiments, and as described above, the user-performed process, including the items, instructions and/or directions, can also be added to a user's user-performed process collection (e.g., a recipe box, a home improvement project collection, etc.). In other embodiments, and as described above, a user can choose to add the user-performed process to their user-performed process collection and/or to add the items associated with the user-performed process to their universal list.

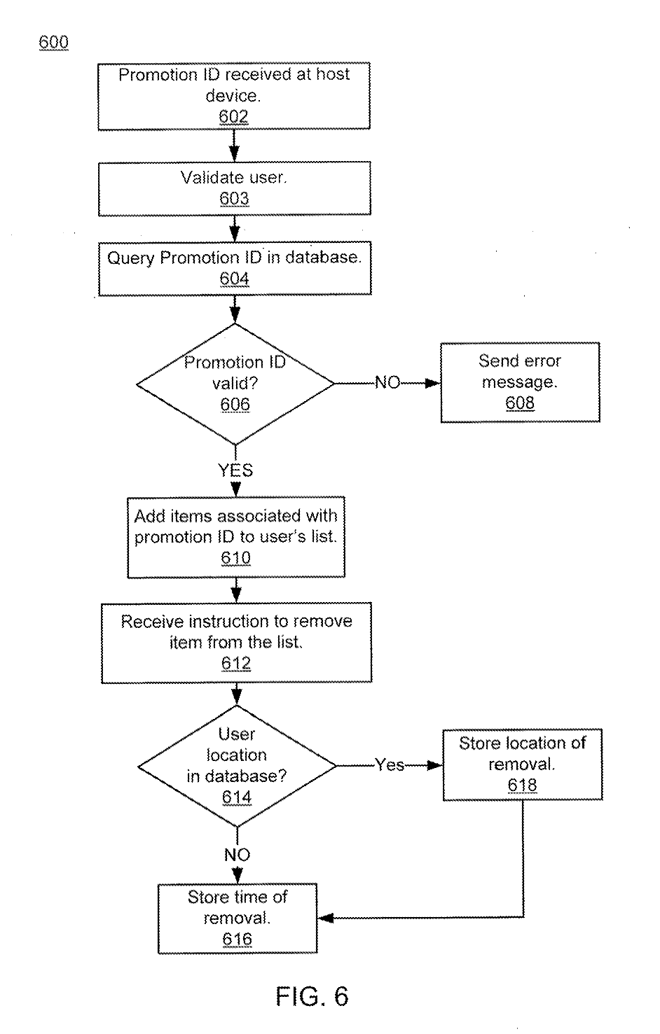

FIG. 6 is a flow chart illustrating a method 600 of updating a universal list, according to another embodiment. In some embodiments, the method 600 can be performed and/or executed at a host device similar to the host device 120 shown and described with respect to FIG. 1. Accordingly, in some embodiments, a processor at a host device, similar to the processor 200 shown and described with respect to FIG. 2, can execute instructions that cause the processor 200 to perform the method 600. The method 600 can be performed as part of a tracking system and/or service.

The method 600 includes receiving a promotion identifier (ID) from a communication device, at 602. More specifically, in some embodiments, a communication module (similar to the communication module 202 shown and described with respect to FIG. 2) can receive the promotion ID from the communication device. In some embodiments, the promotion ID can be associated with a promotion for a product and/or item.

In some embodiments, the promotion ID can be sent to the host device subsequent to a user of the communication device receiving the promotion ID. In some embodiments, the promotion ID can be presented to a user of the communication device using online advertisements (e.g., a website, an email transmission, a popup window, a mobile device application, etc.) and/or offline advertisements (e.g., a television advertisement, a billboard advertisement, an audio advertisement (e.g., a radio advertisement, a podcast advertisement, etc.), an advertisement in a print medium (magazine, newspaper, coupon), a word-of mouth referral, etc.). In still other embodiments, the promotion ID can be presented to the user by any other suitable manner. Additionally, the promotion ID can be presented to a user in any suitable form. For example, the promotion ID for an item, promotion, and/or process can be presented to a user using the actual numerical and/or alphanumeric promotion ID (e.g., visually, audibly and/or tactilely), an optical pattern (e.g., a high capacity color barcode, a QR code, a two-dimensional barcode, a one-dimensional barcode, a black light pattern, etc.), an RF pattern, within an application on a PC or mobile device, and/or the like.

The user can send the promotion ID to the host device using any suitable communication mode (e.g., any suitable format), such as, for example, email, text messages (e.g., SMS messages), instant messages, optical pattern transmissions (e.g., scan of a barcode on a product's packaging, on an advertisement, etc.), a mobile device application, a website, a PC application, an interactive advertisement (e.g., a Flash advertisement on a website), an ITV application (e.g., user uses their TV remote to select and/or enter promotion ID), TCP/IP transmissions, interactive voice response (e.g., via touch tones and/or voice recognition), and/or the like.

The host device can determine, using a communication identifier (e.g., telephone number, email address, instant message identifier, username (e.g., from user input, via a third-party application using an application programming interface (API), etc.), password, PIN, etc.) associated with the message having the promotion ID, with which account the message is to be associated, at 603. Similarly stated, the host device can validate the user. For example, as described above, a user can register and/or associate one or more communication identifiers with their account such that they can update their universal list using different communication modes. In some embodiments, if the communication identifier associated with the message is not registered, a new account can be defined.

After the host device determines with which account and/or user the received promotion ID is associated (or after the host device defines a new account), the host device queries a promotion database using the promotion ID, at 604. Such a promotion database can be structurally and functionally similar to the promotion database 126, the promotion database 300, and/or the promotion database 500 shown and described with respect to FIGS. 1, 3 and 5, respectively.

The host device determines whether the promotion ID is valid, at 606. For example, in some embodiments, the host determines if the promotion ID is in the promotion database, is available to that user (e.g., is valid in their geographic region), has not expired, and/or the like. If the promotion ID is not valid, the host device sends an error message to the communication device, at 608. Such an error message can be sent to the communication device using the same communication mode via which the host device received the promotion ID from the communication device at 602. Accordingly, if the promotion ID was received from the communication device via an SMS message, the host device can send the error message to the communication device via an SMS message. Similarly, if the promotion ID was received from the communication device via an email message, the host device can send the error message to the communication device via an email message. In other embodiments, the host device can send the error message via any other communication mode. In still other embodiments, the host device can send the error message via multiple communication modes.

In some embodiments, the error message can notify a user that the promotion ID was not valid (e.g., not recognized by the host device, not available to the user, expired, etc.). Additionally, if the promotion ID was not valid, the error message can provide other possible promotion IDs that are similar to the promotion ID received from the communication device at 602. For example, if the promotion ID received from the communication device at 602 is “12345,” and the promotion ID is not valid, the error message can provide valid promotion IDs “12344” and “12346” and their associated promotion names to the user. Thus, the user can determine if a typographical error was made when sending the initial promotion ID, and can send the correct promotion ID. In other embodiments, the error message can include an advertisement message, another promotion identifier related to an item similar to other items the user previously added to their universal list, an unexpired promotion ID associated with a related item, and/or the like.

If the promotion ID is valid, the items associated with the promotion ID are added to the user's universal list, at 610. More specifically, using the promotion ID, the host device can retrieve the items associated with that promotion ID. Accordingly, using the promotion database 500 (FIG. 5) as an example, if the promotion ID of “20” is received, “BBQ sauce” and “Chicken Breasts” can be added to the user's universal list (i.e., the list associated with the user identified in the step 604 or 606). For another example, using the promotion database 300 (FIG. 3A), if the promotion ID of “2” is received, “Brand Y Paint” can be added to the user's universal list. In some embodiments, if a user has not yet started a universal list, a new universal list can be defined and the items associated with the process ID added to the new universal list. In some embodiments, and as described above, a user-performed process, including the items, instructions and/or directions, can also be added to a user's user-performed process collection (e.g., a recipe box, a home improvement project collection, etc.).

While not shown in FIG. 6, in some embodiments, the tracking system and/or service can perform logic rules and/or verification associated with the user's universal list and/or user-performed process collection prior to adding an item and/or user performed process to the user's universal list and/or user-performed process collection. For example, prior to adding an item to a universal list, the tracking system and/or service can check whether the item is already on the user's universal list. Similarly, if an item is already on the universal list, the tracking system and/or service can update a quantity associated with that item, attach a coupon with that item, and/or the like.

The host device receives an instruction to remove an item from the user's universal list, at 612. More specifically, the user can send an instruction to the host device to remove one or more items from their universal list. The user can send the instruction using any suitable communication mode such as, for example, email, text messages (e.g., SMS messages), instant messages, optical pattern transmissions (e.g., scan of a barcode on a product's packaging, on an advertisement, etc.), a mobile device application, a website, a PC application, an interactive advertisement (e.g., a Flash advertisement on a website), an ITV application (e.g., user uses their TV remote to select and/or enter promotion ID), TCP/IP transmissions, interactive voice response (e.g., via touch tones and/or voice recognition), and/or the like.

The host device determines whether a location of the user substantially at the time the instruction to remove the one or more items from the universal list is sent is in a location database, at 614. More specifically, the host device receives a location identifier (e.g., geo-coordinates) from the communication device substantially at the time the user sends the instruction to remove the item from the list. The host device can compare the location identifier of the communication device with location identifiers of various identifiable locations. If the location identifier of the communication device is within a specified range, radius and/or distance from the location identifier of, for example, a vendor and/or store, the host device can infer that the user purchased the item at that vendor and/or store and store the location of removal in a tracking database, at 618. A time of removal (i.e., the time the user sent the instruction to remove the item from the universal list) can also be stored in the tracking database, at 616.

A vendor and/or manufacturer can use the information stored within the tracking database (e.g., the time and location a user removed an item from their universal list) to determine an effectiveness of a promotion and/or advertisement campaign. For example, a vendor and/or manufacturer can determine a correlation between an offline advertisement campaign (e.g., television advertisements, print advertisements, radio advertisements, etc.) and offline purchases. More specifically, the vendor and/or manufacturer can determine when and/or where a user added an item associated with the promotion to their list (e.g., the time and location at which they obtained the promotion ID) as well as when and/or where a user removed the item associated with the promotion from their list (e.g., the time and location at which they purchased the item associated with the promotion ID). Accordingly, the vendor and/or manufacturer can determine the number of offline purchases at a specific vendor that are directly attributable to that offline promotion.

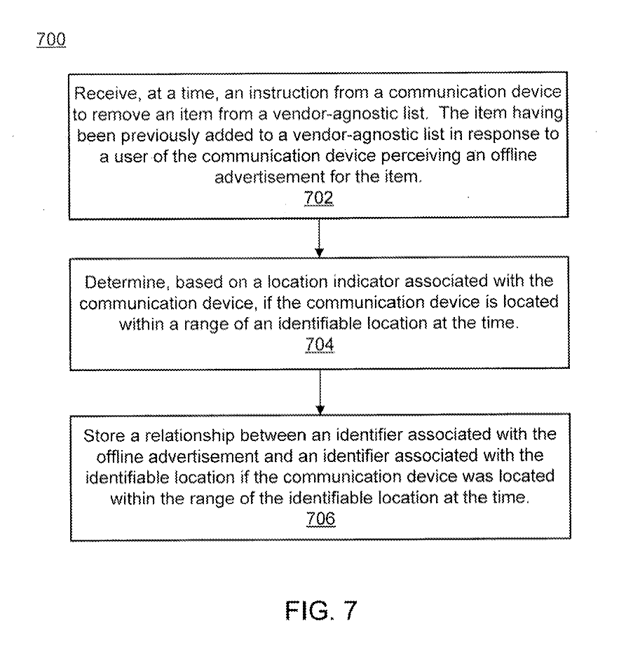

FIG. 7 is a flow chart illustrating a method 700 of updating a tracking database, according to another embodiment. The method 700 includes receiving, at a time, an instruction from a communication device to remove an item from a vendor-agnostic list, at 702. The item was previously added to the vendor-agnostic list in response to a user of the communication device perceiving an offline advertisement for the item. In some embodiments, for example, the signal can be associated with a user removing the item from the vendor-agnostic list. In some embodiments, the item can be added to the vendor-agnostic list in response to a user of the communication device perceiving a television advertisement, a billboard advertisement, an audio advertisement (e.g., a radio advertisement, a podcast advertisement, etc.), an advertisement in a print medium (magazine, newspaper, coupon), a word-of mouth referral, and/or the like.

The method 700 further includes determining, based on a location indicator associated with the communication device, if the communication device is located within a range (e.g., radius and/or distance) of an identifiable location substantially at the time, at 704. In some embodiments, the location indicator can be received by a GPS module, an assisted GPS module, a triangulation module, and/or the like at the communication device.

A relationship between an identifier associated with the offline advertisement and an identifier associated with the identifiable location is stored if the communication device was located within the range of the identifiable location substantially at the time, at 706. For example, if the location indicator associated with the communication device indicates that the communication device is within a range, radius and/or distance of a store and/or vendor, the relationship can be stored. Such a relationship can be used to infer that the user of the communication device purchased the item at that store and/or vendor.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

While shown and described above as determining a location at which a user purchased an item using location information of the user's communication device when the item is removed from the user's universal list, in some embodiments, other indications provided by a user and/or a communication device of a user can be used to determine a location at which a user purchased an item. For example, location information can be sent to a host device in response to the user marking the item as found (e.g., on a checklist). Similarly stated, in such embodiments, location information can be sent to the host device in response to an instruction to change a status of the item on the vendor-agnostic list to a located status. In other embodiments, location information can be sent to a host device in response to the user entering a “shop mode”, in response to a mobile device application of the tracking system and/or service executing for a predetermined amount of time, and/or the like.

In some embodiments, a combination of location information at various times can used to determine a location at which a user purchased an item. For example, a location of a communication device at a time at which the user marks the item as found can be compared with a time at which a user removes the item from their universal list. If, for example, the location at which the user removed the item from their universal list is not within a range of a vendor, but the location at which the user marked the item as found is within a range of a vendor (or vice versa), then the vendor within the range of the location at which the user marked the item as found can be inferred to be the vendor at which the user purchased the item. For another example, if a mobile device application of the tracking system and/or service is executing for a predetermined amount of time at a location within a range of a vendor, but the location at which the user removed the item (e.g., within a time period after the mobile device application was executing for the predetermined amount of time) from their universal list is not within the range of a vendor, then the location at which the mobile device application was executing for the predetermined amount of time can be used as the location at which the item was purchased. In other embodiments, any other combination of location information can be used to determine at which vendor a user purchased an item.

In some embodiments, the redemption of a coupon can be used to determine a location at which a user purchased an item. For example, if a user-specific coupon is redeemed at a vendor, that vendor can provide information to the host device (e.g., a vendor identifier, time of purchase, items purchased, coupons redeemed, user identifier, etc.). Similarly, if a loyalty card is used at a specific vendor, the vendor can provide information to the host device (e.g., a vendor identifier, time of purchase, items purchased, coupons redeemed, user identifier, etc.).

While shown and described above as a user adding one or more items to a universal list by sending an identifier to a host device, in some embodiments a user can add one or more items to their universal list based on a recommendation and/or suggestion made by the tracking system and/or service. For example, the tracking system and/or service can provide a recommendation to a user for a product, coupon, user-performed process, and/or the like. Such a recommendation can be sent to a communication device of the user via, for example, a text message, a mobile application, an email, an instant message, and/or the like. In some embodiments, such a recommendation can be based on, for example, a purchase history of the user, a geographic location of a user, user-defined preferences of a user, the purchase history of friends, a recommendation by a friend (e.g., connected via a social network website), an item added by another user with a similar history as the user, a time of day, a season of year, a day of week, and/or the like. A user can add the recommended product, coupon, user-performed process, and/or the like to their universal list and/or their user-performed process collection by, for example, selecting a link within the recommendation and/or replying to a message (e.g., email, SMS, instant message, etc.) associated with the recommendation.

While shown and described above as using a location module and location information associated with a communication device to infer a store and/or vendor at which a user purchases an item, in other embodiments any other suitable information can be used to infer a store and/or vendor at which the user purchases the item. In some embodiments, for example, a user's purchase history can be used in combination with a type of item removed from a list to infer at which store an item was purchased. For example, if a user generally purchases certain items (e.g., groceries) at a first store but certain other items (e.g., clothing) at another store, when a grocery item is removed from their list, it can be inferred that the user purchased the grocery item at the first store. Similarly, when a clothing item is removed from their list, it can be inferred that the user purchased the clothing item at the second store.

In some embodiments, a user can be asked to verify an inference that the item was purchased at a store and/or vendor. For example, after an inference is made that a user purchased an item at a particular store and/or vendor (e.g., based on a location of the communication device and a location of the store and/or vendor), the user can be presented with a request to verify that the item was purchased at that store and/or vendor. For another example, after an association between the item and the store and/or vendor is stored, a user can modify and/or correct this assumption to reflect an actual store and/or vendor at which they purchased the item. Similarly, in some embodiments, a user can be asked to verify an inference made about where the user added an item to and/or modified an item on their vendor-agnostic list.

In some embodiments, instead of inferring a location at which the user purchased an item, the tracking system and/or service can be configured to ask a user at which store they purchased an item. In such embodiments, an interface asking where the item was purchased can be presented to the user in response to the user indicating that they would like to remove the item from the universal list. In some embodiments, when asking the user where the item was purchased, the user can be provided a list of nearby stores and/or a list of preferred stores to select from. In some embodiments, a user can also add a new store to their preferred list.

In some embodiments, a tracking system and/or service can include a shop mode. When a user begins shopping, they can provide an indication on their communication device that they would like to enter shop mode. Upon entry into shop mode, the tracking system and/or service can determine a location of the user using a GPS of the communication device, cell-tower triangulation, an interne protocol (IP) address of the communication device, and/or the like. In other embodiments, upon entry into shop mode, the tracking system and/or service can ask the user at which store they are located. In some embodiments, such a query can include presenting a list of nearby stores, a list of preferred stores, and/or the like.

In some embodiments, each time a user removes an item from their list they can be asked a purpose for removing the item from their list. For example, upon removing an item from their list, a user can be asked whether or not they purchased the item. If the user indicates that they purchased the item, a location can be determined. If, however, the user indicates that they did not purchase the item, the item can be removed from the list without determining a location.

In some embodiments, advertisements and/or coupons can be presented to a user (e.g., sent from a host device to the user's communication device) based on the items added to the user's vendor-agnostic list. For example, advertisements and/or coupons associated with items associated with a user-performed process can be presented to a communication device after the items have been added to a user's vendor-agnostic list. Accordingly, a user can be provided advertisements and/or coupons for items they intend to purchase. Additionally, location information associated with the use of a coupon can be determined based on location information of a communication device substantially at the time the coupon is used and/or removed from a universal list. Accordingly, it can be inferred at which store and/or vendor the coupon was used.

In some embodiments, a coupon can be assigned a promotion ID. In such embodiments, a coupon can be added to a user's universal list using the promotion ID associated with that coupon. Similar to an item added to a universal list, the tracking system and/or service can infer where and when a user added the coupon and/or where and when a user redeemed and/or used the coupon. Accordingly, in such embodiments a nexus can be established between a user perceiving a coupon and that user purchasing an item based on that coupon. Additionally, in such embodiments a nexus can be established between that coupon and a store at which that coupon was redeemed.

In some embodiments, a universal list can be a wish-list. In such embodiments, for example, a user can use a universal list for a bridal registry, a baby registry, a child's birthday list and/or the like. Such a wish-list can then be shared with other users such that the other users can view and/or purchase items from the wish-list.

In some embodiments, one or more alerts (e.g., email alerts, alert within an application, audio alert, tactile alert, etc.) can be configured with respect to a user's account with a tracking system and/or service. In such embodiments, for example, a user can define an alert associated with an expiration date of one or more coupons and/or promotions, an alert associated with another user adding an item to, removing an item from, and/or modifying an item on a shared list, a friend adding an item to their list, and/or the like. In some embodiments, such alerts can be defined automatically when an item is added to a universal list (e.g., the alert can be associated with a process ID). In other embodiments, such alerts can be manually defined by a user. In still other embodiments, some alerts can be defined automatically while other alerts are manually defined.

In some embodiments, a different version of an item and/or a user-performed process can be added to universal lists of different users based on a geographic indication of the communication device. For example, a recipe can be modified based on altitude, climate, cultural differences and/or the like. Similarly, a promotion, item price, store at which to purchase an item, and/or the like can be different based on geographic information. For example, a manufacturer can have a promotion for a product (e.g., individually added to a universal list or added in association with a user-performed process) with a first price in a first geographic region and a promotion for the product with a second price in a second geographic region. Thus, two users who provide the same process ID to a tracking system and/or service can have different characteristics associated with the item(s) associated with that process ID based on the geographic location of the different users. As discussed above, such a geographic location can be determined using a global positioning system (GPS) of the communication device, triangulation, an internet protocol (IP) address of the communication device, a user profile, and/or the like. Similarly, in some embodiments, a promotion, item price, store at which to purchase an item, and/or the like can be different based on other factors, such as, for example, time of day, day of week, purchase history, purchase history of similar users, purchase history of friends, and/or the like.

While shown and described above as adding items associated with a promotion to a user's universal list, in some embodiments a user can also add items not necessarily associated with a promotion. For example, a user can add items to their universal list without perceiving an advertisement and/or promotion. In some embodiments, a user can add items to their universal list as a reminder to purchase those items. For example, a user can add “milk” and “bread” to their universal list. Such items can be assigned a promotion ID that allows a user to add the items to their universal list. Based on that user removing those items from their universal list, the tracking system and/or service can infer at which vendor and/or store the user purchased those items. Thus, a user's shopping habits can be determined, analyzed and/or evaluated. In some embodiments, the items added to a universal list can be generic (e.g., not brand specific) or brand specific.

In some embodiments, attributes associated with an item can be associated with the item on the universal list. For example, a coupon associated with the item, an expiration date of a coupon or promotion associated with the item, an importance level of the item, a store or list of stores having the item, a product identifier associated with the item (e.g., a universal product code (UPC), a stock-keeping unit (SKU), a serial number, a model number, etc.), a range of product identifiers associated with the item (e.g., certain brand, product line, etc.), and/or the like can be associated with the item on the universal list. In some embodiments, such attributes can be automatically associated with the item in response to receiving an identifier associated with that item and/or a user-performed process including that item. In other embodiments, such attributes can be associated with the item by a user of the universal list. In still other embodiments, some of the attributes are automatically associated while other attributes can be added to the item by the user of the universal list.

In some embodiments, a promotion ID can be used to identify multiple other promotion IDs. In such embodiments, for example, a promotion ID associated with a user-performed process can be used to identify promotion IDs of the items used to perform that user-performed process. Using FIG. 5 as an example, the promotion ID for “BBQ Chicken” (i.e., 20) can be used to identify the promotion IDs for “BBQ Sauce” and “Chicken Breasts” (not shown in FIG. 5). Using the promotion IDs, the items (“BBQ Sauce” and “Chicken Breasts”) can be added to the user's universal list. Similarly, in some embodiments, a promotion ID can be used to identify a brand of products, a product line, and/or the like.

While shown and described above as being associated with a user-performed process or an item, in some embodiments promotion IDs can also be associated with actions. For example, a promotion ID can be associated with sharing a list, defining a new list, deleting a list, adding an alert for an item, subscribing/unsubscribing to a marketing list (e.g., to receive deals of the week, a recipe of the day, etc.), and/or the like. In some embodiments, for example, if a first user sends the promotion ID of “SHARE” with a list identifier and a second user's user ID, the first user's list associated with the list identifier can be shared with the second user. Similarly, for another example, to delete one of a user's lists, the user can send the promotion ID of “DELETE” with a list identifier of the list to be deleted.

In some embodiments, a promotion ID can be associated with a website, application and/or store. For example, when the user adds one or more items to their universal list (e.g., individually and/or as part of a user-performed process), the user can be redirected to a website and/or application associated with an item added. In some embodiments, for example, the user can be redirected to a manufacturer's website, a retailer's website, a social networking application and/or the like. Similarly, in some embodiments, when a user wishes to view details associated with an item on their universal list, they can select the item and/or promotion ID from their universal list. Such a selection can, for example, direct them to the website associated with that promotion ID and/or item.

In some embodiments, a third party application using an application programming interface (API) can be used by a user to interact with (e.g., view, update, add to, remove from, edit, etc.) their universal list. For example, a social networking site can use an API to access a user's universal list and to present the universal list in the social networking site. Such an API provides integration of a tracking system and/or service into other systems, programs, applications, websites, and/or the like.

While shown and described above as each user having a different universal list, in some embodiments universal lists can be shared between users. For example, multiple users within a family (e.g., husband, wife, kids) can have access to the same universal list. This allows each individual within a group to view and/or update a common list.

While shown and described above as having a single universal list, in some embodiments a user can have multiple universal lists. For example, a user can have a home improvement universal list, a grocery/food universal list, and/or any other types of universal lists. In some embodiments, a user can also include an unshared universal list as well as one or more universal lists shared with different other users.

In some embodiments, a range, radius and/or distance used to determine a vendor and/or store at which a user purchased an item on their universal list can increase if the communication device is unable to acquire location information substantially at the time that a user provides an indication to a communication device to remove an item from their universal list. For example, if a communication device acquires location information within a first time period after the user provides an indication to remove an item from their list, a tracking module (e.g., tracking module 204) at a host device can search for vendors and/or stores within a first range, radius and/or distance from the location information to infer a vendor and/or store at which a user purchased an item. If, however, a communication device is unable to acquire location information within the first time period, but later acquires location information, the tracking module at the host device can search for vendors and/or stores within a second range, radius and/or distance from the location information, larger than the first range, radius and/or distance, to infer a vendor and/or store at which a user purchased an item. For another example, the range, radius and/or distance can incrementally, linearly, and/or exponentially increase as the time between the user providing an indication to remove an item from a universal list and the time at which a communication device receives location information increases. Thus, as the time between the user providing an indication to remove an item from a universal list and the time at which a communication device receives location information increases, the number of potential stores and/or vendors at which a user might have purchased the item increases. Similarly stated, the delay between the user providing an indication to remove an item from a universal list and the time at which a communication device receives location information can be indicative of a level of certainty associated with an inference of where the user purchased the item removed from the universal list. A similar method can be used to determine a location at which a user added an item to and/or updated an item on a universal list.

While shown and described above as a communication device acquiring location information and sending the location information to a host device, in other embodiments, a device and/or system external the communication device can be configured to acquire and send the location information to the host device. In such embodiments, a wireless transceiver (e.g., a cell-phone tower, a Wi-Fi transceiver, and/or the like) can determine a location (e.g., within a cell) of a communication device and send that location information directly to a host device (i.e., without sending the location information to the communication device). For example, a wireless transceiver located at a vendor and/or store can receive an identification signal from a communication device within the vendor and/or store. The identification signal can include identification information of the communication device and/or a user of the communication device such as, for example, a device identifier, a user identifier, a tracking system and/or service account identifier, and/or the like. The wireless transceiver can send a signal including the identification information of the communication device and/or user, and an identifier of the store and/or vendor, to the host device. The host device can associate the identifier of the store and/or vendor with signals to add an item to, edit an item on and/or remove an item from a universal list of the user received from the communication device during a time period after receiving the signal. Accordingly, the host device can infer, for example, that items removed during the time period were purchased at that store and/or vendor. In some embodiments, the wireless transceiver can periodically (e.g., every minute, every 5 minutes, etc.) send signals including an identifier of the users and/or communication devices within the store and/or vendor to the host device such that the host device can have updated information associated with the store and/or vendor.

In some embodiments, an unknown location can become an identifiable location based on the characteristics of the signals received from that location. Such characteristics can include, for example, a frequency of signals received from the location, time signals generally received from the location, a number of signals received from the location, a type of the signals generally received from the location, a number of users sending signals from the location, and/or the like. For example, if the host device receives a large number (e.g., greater than a threshold) of “remove” signals from different users at an unknown location, it can be inferred that that unknown location is a store and/or vendor and the location can be identified as a store and/or vendor. For another example, if the host device generally receives a number of “add” signals for a particular user during business hours at an unknown location, it can be inferred that that unknown location is the user's place of business and the location can be identified as the user's place of business. For yet another example, if the host device generally receives a number of “add” signals for a particular user at a single location during all hours of the day, it can be inferred that that user stays at home and the location can be identified as the user's home. In other embodiments, any additional inferences can be made about an unknown location based on the characteristics of the signals received from that location.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. A non-transitory processor-readable medium storing code representing instructions to cause a processor to:
receive, at a time, an indication from a communication device that an item on a vendor-agnostic list has been located, the item having been previously added to the vendor-agnostic list in response to a user of the communication device perceiving an offline advertisement for the item;
determine, based on a location indicator associated with the communication device, if the communication device is located within a range of an identifiable location substantially at the time; and
store a relationship between an identifier associated with the offline advertisement and an identifier associated with the identifiable location if the communication device was located within the range of the identifiable location substantially at the time.

2. The non-transitory processor-readable medium of claim 1, wherein the code representing instructions to cause the processor to store the relationship includes code representing instructions to cause the processor to store a relationship between an identifier associated with the user of the communication device, the identifier associated with the offline advertisement, and the identifier associated with the identifiable location if the communication device was located within a range of the identifiable location substantially at the time.

3. The non-transitory processor-readable medium of claim 1, wherein the communication device is a first communication device, the non-transitory processor-readable medium further comprising code representing instructions to cause the processor to:
receive, before the time, the identifier associated with the offline advertisement for the item from a second communication device.

4. The non-transitory processor-readable medium of claim 1, further comprising code representing instructions to cause the processor to:
receive, before the time, the identifier associated with the offline advertisement for the item from the communication device.

5. The non-transitory processor-readable medium of claim 1, further comprising code representing instructions to cause the processor to:
receive the location indicator from the communication device, the location indicator being associated with a global positioning signal received at the communication device.

6. The non-transitory processor-readable medium of claim 1, wherein the code representing instructions to cause the processor to determine if the communication device is located within the range of the identifiable location substantially at the time includes code representing instructions to cause the processor to query an identifiable location database storing a plurality of location identifiers associated with a plurality of identifiable locations.

7. The non-transitory processor-readable medium of claim 1, wherein the identifier is received via at least one of an instant message, an electronic-mail message, a text message, an optical pattern scan, or a mobile device application.

8. The non-transitory processor-readable medium of claim 1, further comprising code representing instructions to cause the processor to:
send a promotion message associated with the item and the identifiable location to the communication device based on the relationship.

9. The non-transitory processor-readable medium of claim 1, further comprising code representing instructions to cause the processor to:
remove the identifier associated with the item from the vendor-agnostic list in response to the indication.

10. The non-transitory processor-readable medium of claim 1, wherein at least one of a vendor, a home of the user, or an office of the user is located at the identifiable location.

11. The non-transitory processor-readable medium of claim 1, wherein the indication from the communication device is an instruction to remove the item from the vendor-agnostic list.

12. The non-transitory processor-readable medium of claim 1, wherein the indication from the communication device is an instruction to change a status of the item on the vendor-agnostic list to a located status.

13. An apparatus, comprising:
a communication module to receive a first signal from a communication device at a time, the first signal indicating that an item on a vendor-agnostic list has been located, the communication module to receive a second signal indicating a location of the communication device substantially at the time; and
a tracking module to determine, based on the second signal, whether the communication device is located within a range of an identifiable location substantially at the time, the tracking module to store a relationship between an identifier associated with the item, an identifier associated with the identifiable location, and an identifier associated with a user of the communication device if the communication device is located within a range of the identifiable location substantially at the time.

14. The apparatus of claim 13, wherein the tracking module is to store a relationship between the time, the identifier associated with the item, the identifier associated with the identifiable location, and the identifier associated with a user of the communication device if the communication device is located within a range of the identifiable location substantially at the time.

15. The apparatus of claim 13, further comprising:
a promotions module to send a promotion message associated with the identifiable location and the item to the user of the communication device based on the relationship.

16. The apparatus of claim 13, further comprising:
an action module to update, before the time, a vendor-agnostic list to include the identifier associated with the item in response to receiving an identifier associated with an offline advertisement for the item.

17. The apparatus of claim 13, further comprising:
a validation module to query a user database to retrieve the identifier associated with the user based on a phone number of the communication device.

18. The apparatus of claim 13, wherein at least one of a vendor, a home of the user, or an office of the user is located at the identifiable location.

19. A non-transitory processor-readable medium storing code representing instructions to cause a processor to:
update, at a first time, a vendor-agnostic list to include a plurality of identifiers associated with a plurality of items used to perform a process;
receive, at a second time after a first time, an instruction from a communication device to remove at least one item from the plurality of items from the vendor-agnostic list; and
store a relationship between an identifier associated with the process and an identifier associated with an identifiable location if the communication device was located within a range of the identifiable location substantially at the second time.

20. The non-transitory processor-readable medium of claim 19, further comprising code representing instructions to cause the processor to:
receive, before the first time, an indicator associated with an offline advertisement for the process; and
determine, using the indicator before the first time, the plurality of items used to perform the process.

21. The non-transitory processor-readable medium of claim 19, further comprising code representing instructions to cause the processor to:
remove an identifier from the plurality of identifiers associated with the at least one item from the plurality of items from the vendor-agnostic list in response to the instruction.

22. The non-transitory processor-readable medium of claim 19, further comprising code representing instructions to cause the processor to:
send a promotion message associated with the process and the identifiable location to the communication device based on the relationship.

23. The non-transitory processor-readable medium of claim 19, further comprising code representing instructions to cause the processor to:
receive a location indicator from the communication device indicating if the communication device was located within the range of the identifiable location substantially at the second time, the location indicator being associated with a global positioning signal received at the communication device.

24. The non-transitory processor-readable medium of claim 19, further comprising code representing instructions to cause the processor to:
query a location database storing a plurality of location identifiers associated with a plurality of identifiable locations to determine, based on a location indicator associated with the communication device, if the communication device was located within the range of the identifiable location substantially at the second time.

25. The non-transitory processor-readable medium of claim 19, wherein at least one of a vendor, a home of the user, or an office of the user is located at the identifiable location.
